(19) United States
(12) Patent Application Publication
(10) Pub. No.: US 2002/0075596 A1
(43) Pub. Date: Jun. 20, 2002

(54) Grounding device of metal in the drive unit

(75) Inventor: Yongda Chen, Shenzhen (CN)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: VALLEY WOOD LTD. and CHINA NATIONAL ELECTRONICS IMP & EXP CORP.

(21) Appl. No.: 09/983,645

(22) Filed: Oct. 25, 2001

(30) Foreign Application Priority Data
Nov. 2, 2000 (CN) 00257406.3

(51) Int. Cl. G11B 5/10

(52) U.S. Cl. 360/128

(57) ABSTRACT

This utility model belongs to domestic appliances, especially to grounding devices of metal in the drive unit of tape recorders, video players or cameras. This utility model includes chassis, main base, and magnetic head, wherein, a positioning point 3-1 for the magnetic head board is located on the chassis 50; the positioning point 3-1 is connected to the spring 60 through the main base 3; the spring 60 is connected to the magnetic head board 2. The magnetic head 1 is connected to the magnetic head board 2 by screw 4. The metal in the drive unit of this utility model uses a simple grounding device. Therefore, not only the ground effect is improved, but also the grounding spring is saved, and the cost and distortion factor of sound are reduced, and the efficiency is increased.

This utility model belongs to domestic appliances, especially to grounding devices of metal in the drive unit of tape recorders, video players or cameras.

In prior art, the metal in the drive unit of the tape recorders, video players or cameras can not make an electrical connection between magnetic head board 2 and chassis 50 through a spring or similar member 60, because the material of the positioning point 3-1 on the main base is plastic. In order to make the metal in the drive unit ground, the design of most devices is that the magnetic head 1 is connected with the tab 40 and the screw 4, and the screw 4 is connected to the magnetic head board 2, then the chassis 50 is connected to the magnetic head board 2 through the grounding spring 70, and finally the grounding of magnetic head is achieved. (See FIG. 4) however, this kind of design for grounding device of metal in the drive unit requires a lot of components, and the production cost is high, the productivity is low. In addition, the metal in grounding depends on additive intermediate parts, such as the grounding spring, but too many intermediate parts will affect the grounding effect of drive unit and increase the distortion factor of sound.

The objective of this utility model is to overcome the disadvantages of the current grounding device of metal in the drive unit of tape recorders, video players or cameras, namely too many components, high production cost, and low productivity; and to provide a grounding device of metal in the drive unit having low production cost, high efficiency and low distortion factor of sound, without additive parts.

The objective of this utility model is achieved according to the following: The grounding device of metal in the drive unit includes chassis, main base, and magnetic head, wherein,

A positioning point 3-1 for magnetic head board is located on the chassis 50; the positioning point 3-1 is connected to a spring 60 through the main base 3; the spring 60 is connected to the magnetic head board 2 by screw 4.

The magnetic head 1 is connected to the magnetic head board 2.

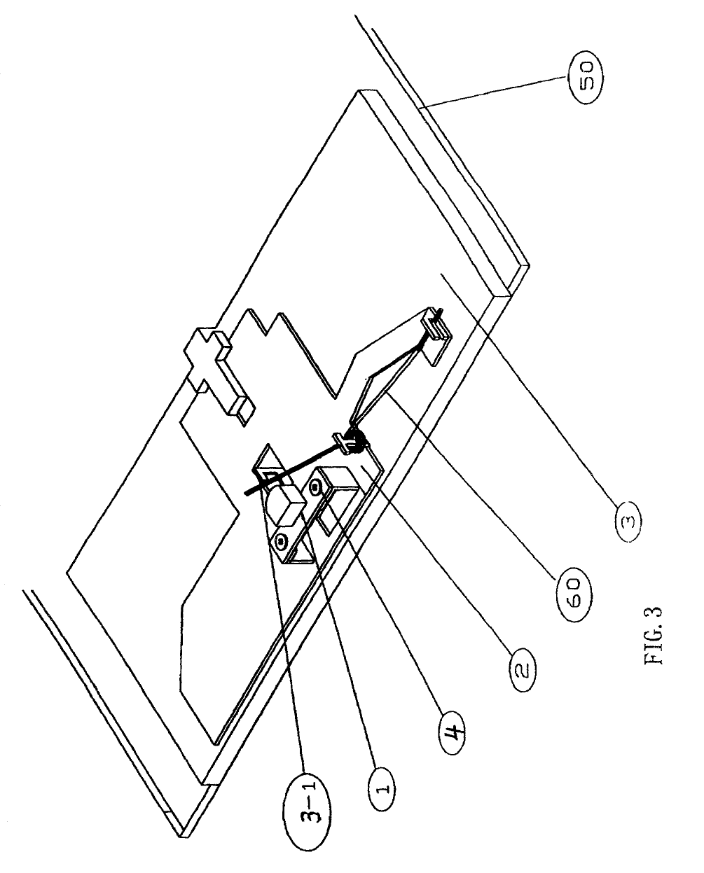

In order for the metal in the drive unit to be grounded, the positioning point 3-1 for the magnetic head board 2 is provided as a part of the chassis, and is made of metal materials. (See FIG. 3)

Since the metal in the drive unit of this utility model uses a simple grounding device, not only the grounding effect is good, but also a grounding spring is saved, the cost and the distortion factor of sound are reduced and the efficiency is increased.

The following is a further description of the technical scheme of this utility model in connection with the appended figures and embodiment.

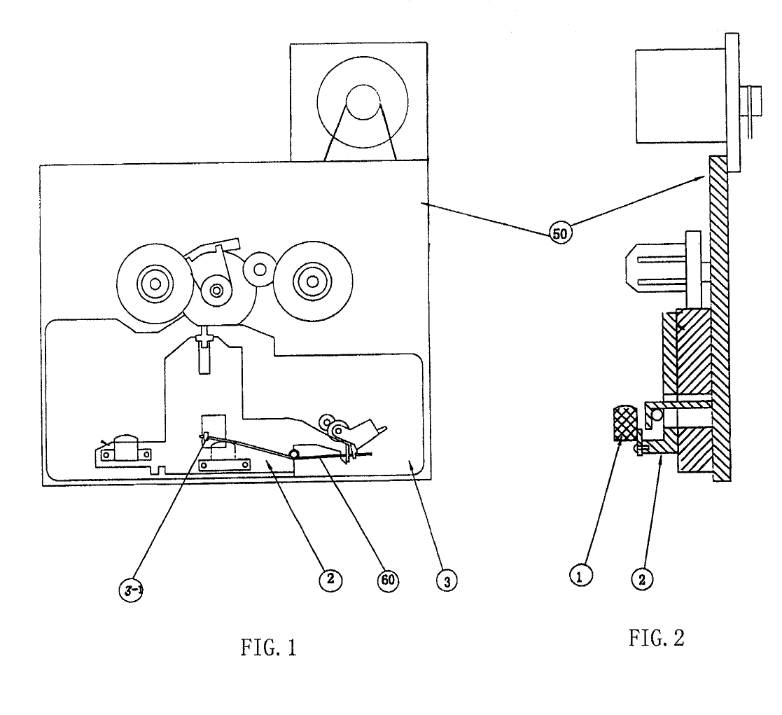

FIG. 1 is a schematic view of this utility model after the grounding device of metal in the drive unit is assembled;

FIG. 2 is a schematic side view of this utility model after the grounding device of metal in the drive unit is assembled;

FIG. 3 is a schematic view of this utility model of the grounding device of metal in the drive unit;

FIG. 4 is a schematic view of the grounding device of magnetic head of tape recorders, video players or cameras in prior art;

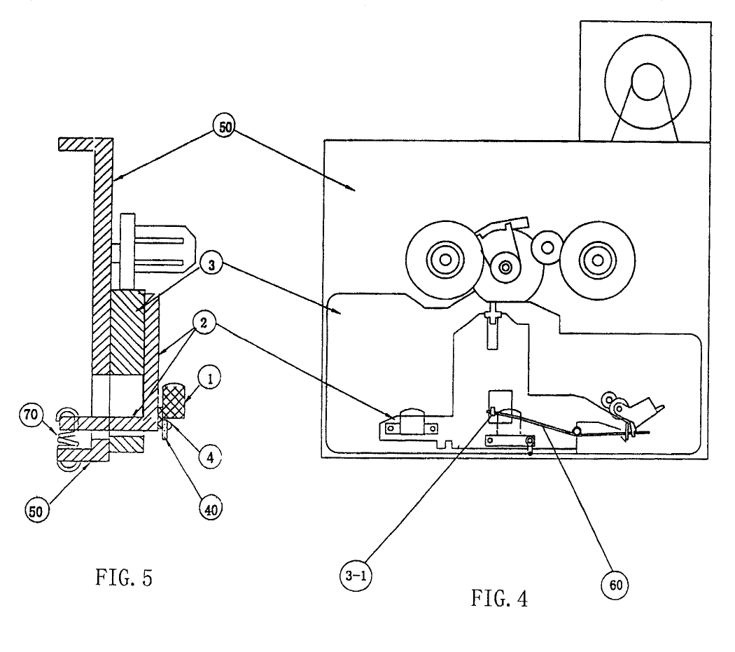

FIG. 5 is a schematic side view of the grounding device of magnetic head of tape recorders, video players or cameras in prior art.

| | | | | | |
|---|---|---|---|---|---|
| 1. | Magnetic head | 2. | Magnetic head | 3. | Main base |
| | | | board | | |
| 3-1. | Positioning point of | 4. | Screw | 40. | Tab |
| | magnetic head board | | | | |
| 50. | Chassis | 60. | Spring | 70. | Grounding Spring |

A preferred embodiment is introduced:

In FIGS. 1, 2 & 3, a positioning point 3-1 for magnetic head board is provided on the chassis 50; the positioning point 3-1 is connected to the spring 60 through the main base 3; the spring 60 is connected to magnetic head board 2. The magnetic head 1 is connected to the magnetic head board 2 by screw 4. This utility model has a good grounding effect, reduces the cost by removing the grounding spring, increases the efficiency and has a low distortion factor of sound.

While this utility model has been described with reference to the figures and embodiments, it will be understood that various changes within the spirit and scope of this utility model as defined by the appended claims are effected.

1. A grounding device of metal in the drive unit, includes chassis, main base, and magnetic head, wherein:
a positioning point 3-1 for magnetic head board 2 is located on the chassis 50; the positioning point 3-1 is connected to a spring 60 through the main base 3, the spring 60 is connected to the magnetic head board 2;
the magnetic head 1 is connected to the magnetic head board 2 by screw 4.

2. The grounding device of metal in the drive unit according to claim 1, wherein, the said positioning point 3-1 for the magnetic head board 2 is made of metal materials.
